(19) United States
(12) Patent Application Publication
(10) Pub. No.: US 2026/0080421 A1
(43) Pub. Date: Mar. 19, 2026

(54) ENABLING ASYNCHRONOUS ANALYTICS VIA AN INTERCEPT DEVICE

(71) Applicant: Adtech LT, UAB, Vilnius (LT)

(72) Inventors: Bronislovas Skridaila, Vilnius (LT); Andrius Stonys, Vilnius (LT)

(73) Assignee: Adtech LT, UAB, Vilnius (LT)

(21) Appl. No.: 18/890,137

(22) Filed: Sep. 19, 2024

(51) Int. Cl. G06Q 30/0201

(52) U.S. Cl. CPC G06Q 30/0201

(57) ABSTRACT

The present disclosure is directed to enabling asynchronous analytics via an intercept device. The intercept device may intercept a request transmitted by a user device to a host server, the request indicating data of interest to be provided by the host server in a response; transmit the request to the host server; asynchronously extract analytic data from the request; transmit the analytic data to an analytics server for performance of analytics on the analytic data; receive, from the analytics server, a result of performance of the analytics on the analytic data; determine, based at least in part on analyzing the result, whether the response from the host server is to be modified; selectively effect modification of the response based at least in part on determining whether the response from the host server is to be modified; and transmit the response to the user device. Various other aspects are contemplated.

### FIELD OF DISCLOSURE

Aspects of the present disclosure generally relate to use of computer hardware and/or software for enabling analytics, and in particular to enabling asynchronous analytics via an intercept device.

### BACKGROUND

Analytics may include the practice of collecting, measuring, and analyzing data related to website usage and performance to improve the same. Cookies and third-party tools like Google Analytics or Adobe Analytics are commonly used to capture and report such metrics. The metrics help website owners and marketers optimize their offerings.

### SUMMARY

In another aspect, the present disclosure contemplates an intercept device, comprising: a processor, and a memory communicatively coupled to the processor, the processor and the memory being configured to: intercept a request transmitted by a user device to a host server, the request indicating data of interest to be provided by the host server in a response; transmit the request to the host server; asynchronously extract analytic data from the request; transmit the analytic data to an analytics server for performance of analytics on the analytic data; receive, from the analytics server, a result of performance of the analytics on the analytic data; determine, based at least in part on analyzing the result, whether the response from the host server is to be modified; selectively effect modification of the response based at least in part on determining whether the response from the host server is to be modified; and transmit the response to the user device.

In one aspect, the present disclosure contemplates a method comprising: intercepting, by an intercept device, a request transmitted by a user device to a host server, the request indicating data of interest to be provided by the host server in a response; transmitting, by the intercept device, the request to the host server; asynchronously extracting, by the intercept device, analytic data from the request; transmitting, by the intercept device, the analytic data to an analytics server for performance of analytics on the analytic data; receiving, by the intercept device from the analytics server, a result of performance of the analytics on the analytic data; determining, by the intercept device based at least in part on analyzing the result, whether the response from the host server is to be modified; selectively effecting, by the intercept device, modification of the response based at least in part on determining whether the response from the host server is to be modified; and transmitting, by the intercept device, the response to the user device.

In another aspect, the present disclosure contemplates a non-transitory computer-readable medium configured to store instructions, which when executed by a processor associated with an intercept device, configures the processor to: intercept a request transmitted by a user device to a host server, the request indicating data of interest to be provided by the host server in a response; transmit the request to the host server; asynchronously extract analytic data from the request; transmit the analytic data to an analytics server for performance of analytics on the analytic data; receive, from the analytics server, a result of performance of the analytics on the analytic data; determine, based at least in part on analyzing the result, whether the response from the host server is to be modified; selectively effect modification of the response based at least in part on determining whether the response from the host server is to be modified; and transmit the response to the user device.

It is to be understood that both the foregoing general description and the following detailed description are exemplary and explanatory in nature and are intended to provide an understanding of the present disclosure without limiting the scope thereof. In that regard, additional aspects, features, and advantages of the present disclosure will be apparent to one skilled in the art from the following detailed description.

### BRIEF DESCRIPTION OF THE DRAWINGS

The accompanying drawings illustrate aspects of systems, devices, methods, and/or mediums disclosed herein and together with the description, serve to explain the principles of the present disclosure. Throughout this description, like elements, in whatever aspect described, refer to common elements wherever referred to and referenced by the same reference number. The characteristics, attributes, functions, interrelations ascribed to a particular element in one location apply to those elements when referred to by the same reference number in another location unless specifically stated otherwise.

The figures referenced below are drawn for ease of explanation of the basic teachings of the present disclosure; the extensions of the figures with respect to number, position, relationship, and dimensions of the parts to form the following aspects may be explained or may be within the skill of the art after the following description has been read and understood. Further, exact dimensions and dimensional proportions to conform to specific force, weight, strength, and similar requirements will likewise be within the skill of the art after the following description has been read and understood.

The following is a brief description of each figure used to describe the present disclosure, and thus, is being presented for illustrative purposes only and should not be limitative of the scope of the present disclosure.

FIG. 1 is an illustration of an example system associated with enabling asynchronous analytics via an intercept device, according to various aspects of the present disclosure.

FIG. 2 is an illustration of an example flow associated with enabling asynchronous analytics via an intercept device, according to various aspects of the present disclosure.

FIG. 3 is an illustration of an example process associated with enabling asynchronous analytics via an intercept device, according to various aspects of the present disclosure.

FIG. 4 is an illustration of example devices associated with enabling asynchronous analytics via an intercept device, according to various aspects of the present disclosure.

### DETAILED DESCRIPTION

For the purposes of promoting an understanding of the principles of the present disclosure, reference will now be made to the aspects illustrated in the drawings, and specific language may be used to describe the same. It will nevertheless be understood that no limitation of the scope of the disclosure is intended. Any alterations and further modifications to the described devices, instruments, methods, and any further application of the principles of the present disclosure are fully contemplated as would normally occur to one skilled in the art to which the disclosure relates. In particular, it is fully contemplated that the features, components, and/or steps described with respect to one aspect may be combined with the features, components, and/or steps described with respect to other aspects of the present disclosure. For the sake of brevity, however, the numerous iterations of these combinations may not be described separately. For simplicity, in some instances the same reference numbers are used throughout the drawings to refer to the same or like parts.

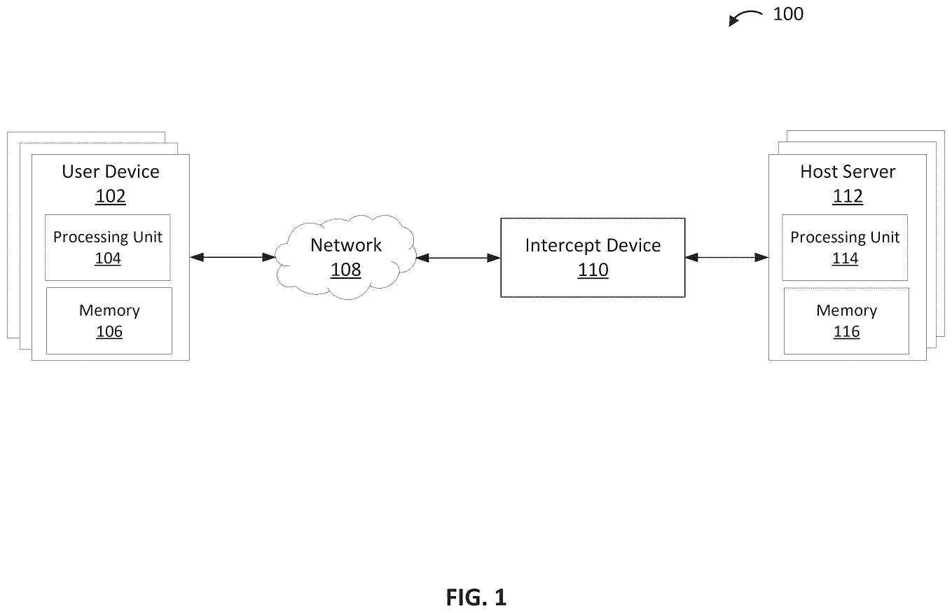

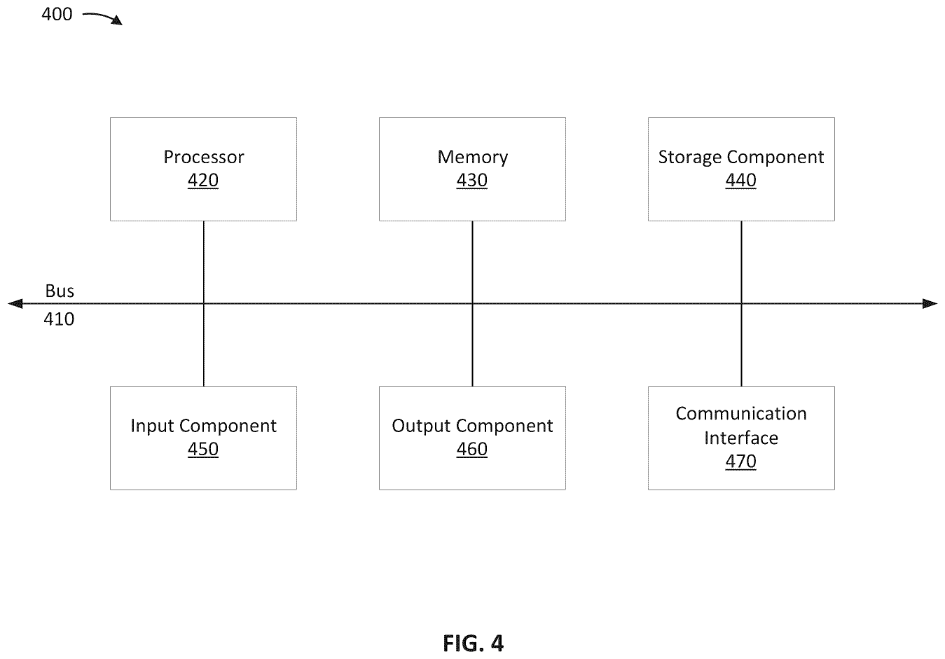

FIG. 1 is an illustration of an example system 100 associated with enabling asynchronous analytics via an intercept device, according to various aspects of the present disclosure. The system 100 includes one or more user devices 102 communicating with one or more host servers 112 over a network 108 (e.g., Internet). A user device 102 may include a processing unit 104 and a memory 106. Similarly, a host server 112 may include a processing unit 114 and a memory 116. The host server may host one or more websites to publish content (e.g., information, audio, video, or a combination thereof), and the user device 102 may utilize an installed client application (e.g., web browser, software application, etc.) to access the content published by the host server 112. In some aspects, the host server 112 may configure and deploy an intercept device 110 to intercept communication between the user device 102 and the host server 112. In some aspects, the intercept device may be configured to intercept the communication based at least in part on receiving, from the host server, information indicating IP addresses and/or domain names associated with the user device and/or the host server. The intercept device 110 may also include an associated processing unit and a memory (see, e.g., FIG. 4).

In some aspects, the user device 102 may utilize the client application to access a website hosted by the host server 112. For instance, the client application may allow a user to input a website Uniform Resource Locator (URL), navigate the website, make selections by clicking links and/or buttons on the website, and make a request for data of interest. The client application may transmit the request over the network 108 to the host server 112, where the website is stored/hosted. The host server 112 may receive and process the request, retrieve the data of interest, and provide the data of interest to the user device 102 over the network 108. The client application may render the data of interest into audio and/or visual format on the user device 102.

The user device 102 may be a physical computing client device capable of installing a client application and of connecting to the network 108. The user device 102 may be, for example, a laptop, a mobile phone, a tablet computer, a desktop computer, a smart device, or the like. In some aspects, the user device 102 may include, for example, Internet-of-Things (IoT) devices such as smart home appliances, smart home security systems, autonomous vehicles, smart health monitors, smart factory equipment, wireless inventory trackers, biometric cyber security scanners, or the like. The user device 102 may include and/or may be associated with a communication interface to communicate (e.g., receive and/or transmit) data.

The host server 112 may include a powerful computer or a system of computers performing functions to store, process, and manage data, files, and applications, while making them accessible over the network 108. The processing unit 114 and the memory 116 may include logical components configured to perform complex operations associated with such functions. The host server 112 may include backend server devices such as, for example, a web server, a file server, a database server, and/or an email server. The host server 112 may be accessed via Internet protocol (IP) addresses and/or domain names associated with the host server 112. Also, the host server 112 may employ various security measures, including firewalls, encryption, and intrusion detection systems, to protect against unauthorized access and cyber threats. In some aspects, the host server 112 may be located in a data center, designed to house host servers. The host server 112 may also be virtualized or cloud-based, as part of a larger, scalable infrastructure provided by cloud services. The stateless infrastructure 110 may include an application programming interface (API) (not shown) to communicate with the client application installed on the user device 102. The host server 112 may include or be associated with a communication interface to communicate (e.g., transmit and/or receive) data.

The network 108 may be a wired or wireless network. In some aspects, the network 108 may include one or more of, for example, a phone line, a local-area network (LAN), a wide-area network (WAN), a metropolitan-area network (MAN), a home-area network (HAN), Internet, Intranet, Extranet, and Internetwork.

The intercept device 110 may be an intermediary device deployed between the user device 102 and the host server 112, and configured to monitor and/or intercept the communication between the user device 102 and the host server 112. In some aspects, the intercept device 110 may handle requests received from various user devices 102 by distributing the requests across the backend server devices associated with the host server 112. In an example, the intercept device 110 may receive a request from the user device 102 and, based at least in part on a destination port number (of a backend server device) included in the request, the intercept device may forward the request to a corresponding backend server device associated with the host server 112. Further, the intercept device 110 may receive a response from the backend server device and forward the response to the user device 102. In some aspects, as discussed below in further detail, the intercept device may selectively effect modification of the response prior to forward the response to the user device 102.

In some aspects, the intercept device 110 may enhance security features by providing, for example, encryption and/or decryption of HTTPS traffic, filtering of malicious requests, and hiding and internal structure of the backend server devices from the open network 108. In some aspects, the intercept device 110 may cache content (e.g., popular content requested by a plurality of user devices) received from the backend server devices in the responses to reduce a load on the backend server devices and to speed up response times by providing the cached content in response to a user device's request instead of querying the backend server device for the cached content.

One or more devices (e.g., user device 102, intercept device 110, host server 112, etc.) included in example 100 shown in FIG. 1 may further be associated with one or more components such as, for example, a controller/processor, a memory, a communication interface, or a combination thereof (e.g., FIG. 4). In some aspects, the one or more components may be separate and distinct from each other. Alternatively, in some aspects, the one or more components may be combined with another one of the one or more components. In some aspects, the one or more components may be local with respect to another one of the one or more components. Alternatively, in some aspects, the one or more components may be located remotely with respect to another one of the one or more components. Additionally, or alternatively, the one or more components may be implemented at least in part as software stored in a memory for execution by a processor. For example, a component (or a portion of a component) may be implemented as instructions or code stored in a non-transitory computer-readable medium and executable by a controller or a processor to perform the functions or operations of the component. Additionally, the one or more components may be configured to perform one or more functions described as being performed by another one of the one or more components.

As indicated above, FIG. 1 is provided as an example. Other examples may differ from what is described with regard to FIG. 1.

A host server may wish to perform analytics for business reasons aimed at improving performance, security, effectiveness to engage a user, and user experience associated with websites and/or content published by the host server. The analytics may assist in understanding user behavior by providing analytic information associated with the user visiting the website and/or consuming the content. For instance, the analytic information may indicate, among other things, an identity of the user, a demographic associated with the user, a location of the user, interactions of the user with the website, and/or a pattern of behavior of the user while visiting the website and/or consuming the content. By analyzing the analytic information, the host server may determine interests of the user and aspects of the website/content that the user found appealing (and/or unappealing). Such determinations may enable the host server to improve the website/content to encourage engagement of the user and to enhance user experience. In addition to understanding user behavior, the analytics may enable the host server to analyze traffic patterns and/or identify security vulnerabilities, thereby enabling the host server to enact proactive measures and avoid potential security threats (e.g., unauthorized access attempts, DDOS attacks, etc.).

The host server may utilize cookies to perform the analytics. In an example, the host server may deploy cookies to be stored in association with client applications installed on user devices to collect the analytic data. The cookies may enable the host server to collect the analytic data during a single session or across multiple sessions of the user visiting the website. The cookies may also enable the host server to record specific interactions, such as form submissions and clicks on buttons or links on the website. In addition, the cookies may enable the host server to track sources of traffic, the sources including search engines, social media platforms, referral sites, or a combination thereof. The host server may also use third-party cookies to collect the analytic data. This may be accomplished by, for example, calling third-party application programming interfaces (APIs) via JavaScript.

Based at least in part on utilizing the cookies, the host server may gather detailed analytic data that provides insights into user behavior, thereby enabling the host server to tailor content on the website, optimize website performance, and execute related business-friendly strategies. Also, security measures may be implemented proactively to avoid the potential security threats.

In some cases, the user may prevent the host server from utilizing cookies. For instance, the user may decline utilization of cookies associated with the website and/or install an ad-blocking tool that avoids utilization of third-party cookies. In such cases, collection and accuracy of the analytics is adversely affected. In an example, without utilization of cookies, the host server may be unable to adequately collect the analytic data related to, for example, tracking user interactions with the website. This may lead to gaps in accurate understanding of the user behavior and/or website performance. Further, the host server may be unable to proactively identify sources of traffic and avoid the potential security threats therefrom. Without an accurate understanding of the user behavior and/or website performance and without being able to proactively identify and avoid the potential security threats, the host server may inefficiently expend resources (e.g., management resources, memory resources, computational/processing resources, power consumption resources, system bandwidth, network resources, etc.) to enable tailored content and to mitigate the effects of observed security threats. Based at least in part on a connection between the user device and the host server, the user device may also be affected by the potential security threats that affect the host server. In this case, the user device may also expend resources (e.g., management resources, memory resources, computational/processing resources, power consumption resources, etc.) to mitigate the effects of the security threats.

Various aspects of systems and techniques discussed in the present disclosure provide enabling asynchronous analytics via an intercept device. When a host server is unable to utilize cookies to perform analytics, the host server may configure and deploy an intercept device between the user device and the host server to enable asynchronous analytics. In some aspects, the intercept device may intercept one or more requests transmitted by a user device to the host server, may forward the one or more requests to the host server, may intercept one or more responses to the one or more requests from the host server, and may transmit the one or more responses to the user device. Asynchronously, the intercept device may continuously extract analytic data from the one or more requests and/or the one or more responses. Such analytic data may include one or more of, for example, an IP address associated with the user device, identity of a web browser and/or software application utilized by the user device to transmit the request, a unique fingerprint indicating information (e.g., a session identifier, a session ticket, etc.) regarding the session between the user device and the host server, a requested landing page of a website, a previously visited page of the website, source of requests, form submissions and clicks on buttons or links on the website, page views, unique visitors, bounce rates, session duration, and other analytic data/information discussed elsewhere herein. In some aspects, the intercept device may utilize the extracted IP address to determine a location of the user device, and provide the determined location as analytic data to the analytics server. Without delaying the forwarding of the one or more requests to the host server, the intercept device may asynchronously and continuously transmit extracted analytic data to a dedicated analytics server. The analytics server may continuously perform analytics on the analytic data, and may transmit results of performing the analytics to the intercept device. Based at least in part on receiving the results, the intercept device may determine, in real time, whether to selectively effect modification of the one or more responses prior to forwarding the one or more responses to the user device. In other words, the intercept device may determine user behavior and/or website performance based at least in part on the results, and may determine that user behavior and/or website performance may be enhanced by modifying the one or more responses. In this case, the intercept device may select to effect modification of the one or more responses by (i) itself modifying the one or more responses and/or (ii) communicating with the host server to receive modified one or more responses from the host server. Because nothing (e.g., cookies) is stored on the user device, the user device does not block utilization of the intercept device for collection of the analytic data.

In this way, without utilizing cookies, the intercept device may enable the host server to gather detailed analytic data that provides insights into user behavior, thereby enabling the host server to tailor content on the website, optimize website performance, and execute related business-friendly strategies. Security measures may also be implemented proactively to avoid the potential security threats. Further, deployment of the intercept device enables speedy execution of the one or more requests and reduction of a load on the host server, thereby preventing the host server from becoming overwhelmed. As a result, the host server and the user device may efficiently expend resources (e.g., management resources, memory resources, computational/processing resources, power consumption resources, system bandwidth, network resources, etc.) to enable tailored content and to mitigate the effects of the potential security threats.

In some aspects, an intercepting device may intercept a request transmitted by a user device to a host server, the request indicating data of interest to be provided by the host server in a response; transmit the request to the host server; asynchronously extract analytic data from the request; transmit the analytic data to an analytics server for performance of analytics on the analytic data; receive, from the analytics server, a result of performance of the analytics on the analytic data; determine, based at least in part on analyzing the result, whether the response from the host server is to be modified; selectively effect modification of the response based at least in part on determining whether the response from the host server is to be modified; and transmit the response to the user device.

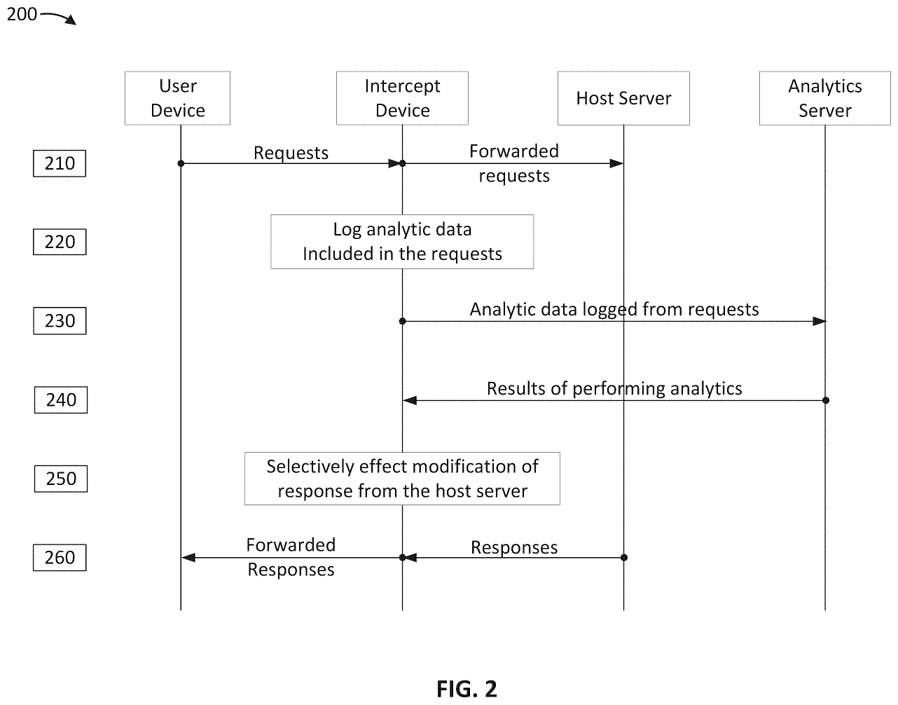

FIG. 2 is an illustration of an example flow 200 associated with enabling asynchronous analytics via an intercept device, according to various aspects of the present disclosure. The example flow 200 may include a user device, an intercept device, a host server, and an analytics server in communication with one or more of each other over a network (e.g., Internet). In some aspects, when cookies may not be utilized, the host server may configure the intercept device and/or the analytics server to operate as discussed below to enable the asynchronous analytics.

As shown by reference numeral 210, the user device may transmit one or more requests to the host server. In some aspects, the one or more requests may be associated with requesting data of interest (e.g., a webpage of a website, content, etc.) published by the host server. The data of interest may include, for example, text data, audio data, video data, or a combination thereof. In some aspects, the one or more requests may include Hypertext Transfer Protocol (HTTP) requesting data of interest such as, for example, a website, filling forms on the website, clicking buttons and/or links on the website, navigating from one page of the website to another, downloading content, or the like. In some aspects, the user device may transmit the one or more requests during a single session between the user device and the host server. In some aspects, the user device may transmit the one or more requests during multiple different sessions between the user device and the host server. Although only one user device is depicted in FIG. 2, the present disclosure contemplates any number of user devices transmitting respective one or more requests to the host server.

Also as shown by reference numeral 210, based at least in part on deployment of the intercept device, the one or more requests may be intercepted or received by the intercept device. Further, without delay, the intercept device may forward the one or more requests to the host server, which may process the one or more requests and provide one or more responses (e.g., homepage of a requested website) to the user device via the intercept device.

In some aspects, as shown by reference numeral 220, the intercept device may asynchronously log (e.g., extract and store) analytic data included in the one or more requests in a memory associated with the intercept device. Such analytic data may include one or more of, for example, an IP address associated with the user device, a determined location of the user device, identity of a web browser and/or software application utilized by the user device to transmit the request, a determined unique fingerprint indicating information (e.g., a session identifier, a session ticket, etc.) regarding the session or sessions between the user device and the host server, a requested landing page of a website, a previously visited page of the website, source of requests, form submissions and clicks on buttons or links on the website, timestamps, interaction details, any associated metadata, and other analytic data/information discussed elsewhere herein. In some aspects, the unique fingerprint may be determined by the intercept device based at least in part on utilizing methods that capture specific fields from the SSL/TLS handshake messages exchanged between the user device and the host server. These methods specifically target the “ClientHello” message and may capture fields such as SSL/TLS version, cipher suites, extensions, or a combination thereof.

Further, as shown by reference numeral 230, the intercept device may asynchronously transmit the analytic data, logged from the one or more requests, to the analytics server. The analytics server may aggregate the analytic data to form meaningful data sets by grouping one or more pieces of data included in the analytic data. For instance, the analytics server may aggregate the analytic data by grouping data associated with a given session between the user device and the host server, by grouping data collected within a given time interval, by grouping data based at least in part on types of interactions, etc. In some aspects, the analytics server may clean the analytic data to remove duplicate instances of data and to correct errors and/or inconsistencies.

The analytics server may analyze the aggregated and cleaned data to identify patterns and/or trends associated with the one or more requests, which assist in determining user behavior. For instance, the analytics server may identify patterns associated with page views, click paths, session durations, and/or conversion rates associated with purchasing and/or downloading the published content. In some aspects, the analytics server may segment user devices based on similar behavior, similar demographics, and other related criteria to indicate user behavior.

The analytics server may then generate results of the analysis that summarize key metrics and insights to indicate user behavior. In one example, the results may indicate a type of content found interesting by the user device and/or a type of content that the user device may find interesting (e.g., a type of content that the user device may be likely to purchase and/or download from the website). In another example, the results may indicate a type of content found uninteresting by the user device and/or a type of content that the user device may find uninteresting (e.g., a type of content that the user device may be unlikely to purchase and/or download from the website). In yet another example, the results may indicate a position on a webpage that is likely to draw a user's attention and/or induce an action (e.g., a click) by the user device. As shown by reference numeral 240, the analytics server may transmit to the intercept device the results of performing the analytics.

As shown by reference numeral 250, based at least in part on receiving the results of performing the analytics, the intercept device may selectively effect modification of the one or more responses from the host server. In some aspects, the intercept device may analyze the results of performing the analytics, and may determine the user behavior. Based at least in part on determining the user behavior, the intercept device may determine, in real time, whether to modify the one or more responses. In some aspects, the intercept device may determine that modifying the responses may not optimize user experience and/or increase the conversion rates. In this case, the intercept device may refrain from effecting modification of the one or more responses.

Alternatively, in some aspects, the intercept device may determine that modifying the one or more responses may optimize user experience and/or increase the conversion rates. In this case, the intercept device may select to modify the one or more responses. In some aspects, the intercept device may itself modify the one or more responses. For instance, the intercept device may utilize a local writer (e.g., modification application) associated with the intercept device to introduce, for example, a pop-up or a banner including data specific to the user device that could enhance the user experience and/or increase the conversion rates. In some aspects, the intercept device may communicate (e.g., transmit and/or receive messages) with the host server to request and receive additional information for the intercept device to modify the one or more responses. In some aspects, the modifications may include replacing partially or entirely, the content included in the one or more responses. In some aspects, the intercept device may modify and/or add custom headers in the one or more responses. In an example, the intercept device may customize a header to include a redirect URL to assist the user device in navigating to a webpage that may be of more interest to the user device. In another example, the intercept device may customize a header to include information indicating additional functionalities and/or content provided by the host server that may be of interest to the user device. In some aspects these custom headers may be formatted differently (e.g., pre-fixed with information to distinguish) from standard headers included in HTTP responses. Based at least in part on the different formatting, the user device may understand that these custom headers include custom information for the user device. The user device may access the custom information for consumption by the user device.

Alternatively, in some aspects, upon intercepting the one or more responses, the intercept device may transmit a message requesting the host server to modify and retransmit the one or more responses. The message may indicate the modifications to be made to the one or more responses, the modifications being determined by the intercept device based at least in part on determining user behavior.

In some aspects, the intercept device may select to modify the one or more responses independent of the results provided by the analytics server. For instance, the intercept device may select to modify the one or more responses based at least in part on static analytic data (e.g., IP address of the user device, location of the user device, etc.) logged by the intercept device.

In one example, the intercept device may determine that the IP address of the user device is associated with a given Internet service provider (ISP) that is providing network services to the user device. In this case, the intercept device may determine that the ISP providing network services to the user device imposes limits on a download speed and/or an upload speed associated with communicating data. As a result, when the intercept device determines that the ISP imposes such limits, the intercept device may determine that the one or more responses is to be modified to include data (e.g., text data and/or graphic data) that is less likely to exceed an imposed limit while being downloaded and/or uploaded as compared to data (e.g., audio data and/or video data) that is more likely to exceed the imposed limit while being downloaded and/or uploaded.

In another example, the intercept device may determine, based at least in part on the IP address of the user device, a given type of technology (e.g., stationary technology such as Wi-Fi or mobile technology such as satellite or 5G) being used by the user device to access the network. For instance, intercept device may determine that the IP address of the user device falls within a range of IP addresses associated with stationary technology or that the IP address of the user device falls within a range of IP addresses associated with mobile technology. As a result, when the intercept device determines that the user device is utilizing stationary technology, the intercept device may determine that the one or more responses is to be modified to include data (e.g., large files, high-definition video streaming, etc.) that is compatible with utilization of stationary technology. Similarly, when the intercept device determines that the user device is utilizing the mobile technology, the intercept device may determine that the one or more responses is to be modified to include data (e.g., smaller files, text data, graphic data, low latency data, etc.) that is compatible with utilization of mobile technology.

In yet another example, the intercept device may determine the location of the user device. Based at least in part on determining the location of the user device, the intercept device may include information specific to the location of the user device. For instance, the intercept device may modify the one or more responses to include information regarding events (e.g., sports events, entertainment events, etc.) taking place in and around the location of the user device.

Other examples of modifications to the one or more responses by the intercept device and/or by the host server (based at least in part on receiving the message from the intercept device) include customized recommendations or content (e.g., show products related to items the user has viewed or searched for before) (e.g., alter webpage to highlight genres or shows that the user device has requested previously), personalized advertisements relevant to user interests (e.g., advertisements for vacation packages or travel gear when determined that user is interested in traveling), user interface with customized layout or design based at least in part on user preferences (e.g., display text and/or graphics in specific positions on the website based at least in part on detecting a threshold amount of clicks in the specific positions (e.g., top of page, side of page, etc.) (e.g., display text and/or graphics in specific positional relationships with each other on the website to aid or enhance engagement), customized settings to conform with user device preferences (e.g., automatically translating content in a given language based at least in part on determining prior translation actions and/or determining a location of the user device) (e.g., automatically changing a font size based at least in part on determining prior actions), customize website navigation (e.g., automatically skip a middle (second) webpage between a first (homepage) webpage and a third webpage based at least in part on determining that the user device commonly navigates to the third page from the first webpage), customized time-sensitive content (e.g., show a special discount offer in a pop-up based at least in part on detecting (time spent on the checkout page, clicks indicating browsing of other products while on checkout page, etc.) that the user device is about to leave the webpage or website without completing a purchase).

Based at least in part on selectively effecting modification of the one or more responses, as shown by reference numeral 260, the intercept device may receive the one or more responses from the host server and may forward the responses to the user device.

In this way, without utilizing cookies and/or similar third party tools, the intercept device may enable the host server to gather detailed analytic data that provides insights into user engagement, thereby enabling the host server to tailor content on the website, optimize website performance, and execute related business-friendly strategies. Security measures may also be implemented proactively to avoid the potential security threats. Further, deployment of the intercept device enables speedy execution of the one or more requests and reduction of a load on the host server, thereby preventing the host server from becoming overwhelmed. As a result, the host server and the user device may efficiently expend resources (e.g., management resources, memory resources, computational/processing resources, power consumption resources, system bandwidth, network resources, etc.) to enable tailored content and to mitigate the effects of observed security threats. In some aspects, to respect and protect a privacy of the user device, each piece of analytic data gathered by the intercept device is stored only in a random access memory associated with the intercept device and/or the analytic server, and each piece of analytic data is deleted immediately upon performance of analytics on each piece of data.

As indicated above, FIG. 2 is provided as an example. Other examples may differ from what is described with regard to FIG. 2.

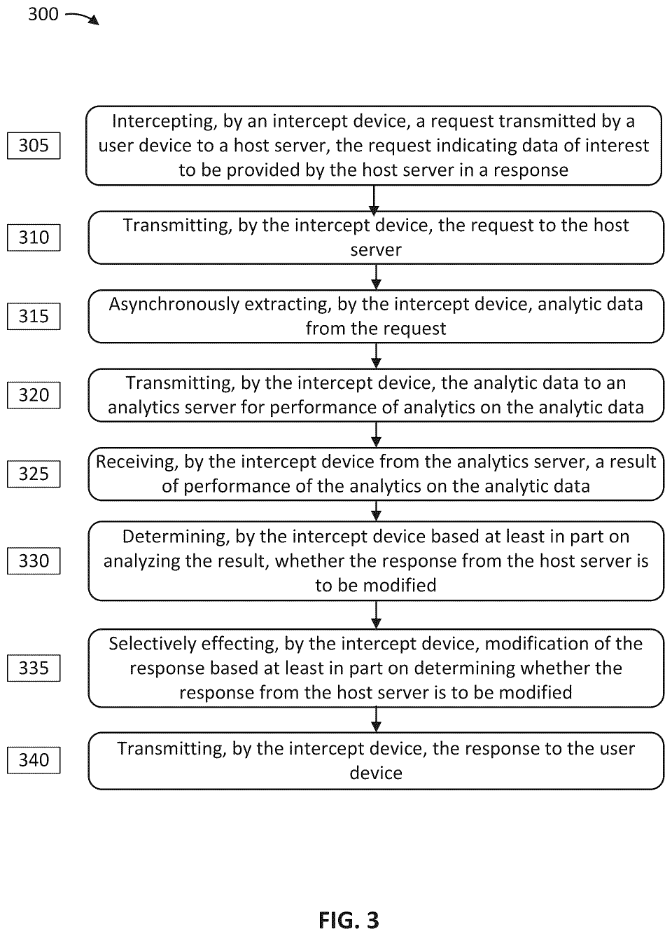

FIG. 3 is an illustration of an example process 300 associated with enabling asynchronous analytics via an intercept device, according to various aspects of the present disclosure. In some aspects, the process 300 may be performed by a memory (e.g., memory 430) and/or processor/controller (e.g., processor 420) associated with the intercept device.

As shown by reference numeral 305, process 300 may include intercepting, by an intercept device, a request transmitted by a user device to a host server, the request indicating data of interest to be provided by the host server in a response. For instance, the intercept device may utilize the associated processor/controller to intercept a request transmitted by a user device to a host server, the request indicating data of interest to be provided by the host server in a response, as discussed elsewhere herein.

As shown by reference numeral 310, process 300 may include transmitting, by the intercept device, the request to the host server. For instance, the intercept device may utilize the associated processor/controller and an associated communication interface (e.g., communication interface 470) to transmit the request to the host server, as discussed elsewhere herein.

As shown by reference numeral 315, process 300 may include asynchronously extracting, by the intercept device, analytic data from the request. For instance, the intercept device may utilize the associated processor/controller to asynchronously extract analytic data from the request, as discussed elsewhere herein.

As shown by reference numeral 320, process 300 may include transmitting, by the intercept device, the analytic data to an analytics server for performance of analytics on the analytic data. For instance, the intercept device may utilize the associated processor/controller and communication interface to transmit the analytic data to an analytics server for performance of analytics on the analytic data, as discussed elsewhere herein.

As shown by reference numeral 325, process 300 may include receiving, by the intercept device from the analytics server, a result of performance of the analytics on the analytic data. For instance, the intercept device may utilize the processor/controller and communication interface to receive, from the analytics server, a result of performance of the analytics on the analytic data, as discussed elsewhere herein.

As shown by reference numeral 330, process 300 may include determining, by the intercept device based at least in part on analyzing the result, whether the response from the host server is to be modified. For instance, the intercept device may utilize the associated processor/controller to determine, based at least in part on analyzing the result, whether the response from the host server is to be modified, as discussed elsewhere herein.

As shown by reference numeral 335, process 300 may include selectively effecting, by the intercept device, modification of the response based at least in part on determining whether the response from the host server is to be modified. For instance, the intercept device may utilize the associated processor/controller to selectively effect modification of the response based at least in part on determining whether the response from the host server is to be modified, as discussed elsewhere herein.

As shown by reference numeral 340, process 300 may include transmitting, by the intercept device, the response to the user device. For instance, the intercept device may utilize the associated processor/controller and communication interface to transmit the response to the user device, as discussed elsewhere herein.

Process 300 may include additional aspects, such as any single aspect or any combination of aspects described below and/or in connection with one or more other processes described elsewhere herein.

In a first aspect, in process 300, selectively effecting modification of the response includes the intercept device utilizing a local writer to modify the response.

In a second aspect, alone or in combination with the first aspect, in process 300, selectively effecting modification of the response includes the intercept device transmitting a message to request additional information from the host server to enable the intercept device to modify the response.

In a third aspect, alone or in combination with the first through second aspects, in process 300, selectively effecting modification of the response includes the intercept device adding a custom header that is formatted to indicate to the user device that the custom header includes information customized for the user device.

In a fourth aspect, alone or in combination with the first through third aspects, in process 300, selectively effecting modification of the response includes the intercept device transmitting a message to the host server for the host server to modify the response.

In a fifth aspect, alone or in combination with the first through fourth aspects, in process 300, selectively effecting modification of the response includes selectively effecting modification of the response without utilizing cookies.

In a sixth aspect, alone or in combination with the first through fifth aspects, process 300 may include determining, based at least in part on analyzing the result, a behavior of a user of the user device while communicating with the host server.

Although FIG. 3 shows example blocks of the process, in some aspects, the process may include additional blocks, fewer blocks, different blocks, or differently arranged blocks than those depicted in FIG. 3. Additionally, or alternatively, two or more of the blocks of the process may be performed in parallel.

As indicated above, FIG. 3 is provided as an example. Other examples may differ from what is described with regard to FIG. 3.

FIG. 4 is an illustration of example devices 400, according to various aspects of the present disclosure. In some aspects, the example components 400 may form part of or implement the systems, devices, environments, infrastructures, components, or the like described elsewhere herein (e.g., FIG. 1) and may be used to perform the example processes described elsewhere herein. The example components 400 may include a universal bus 410 communicatively coupling a processor 420, a memory 430, a storage component 440, an input component 450, an output component 460, and a communication interface 470.

Bus 410 may include a component that permits communication among multiple components of a device 400. Processor 420 may be implemented in hardware, firmware, and/or a combination of hardware and software. Processor 420 may take the form of a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some aspects, processor 420 may include one or more processors capable of being programmed to perform a function. Memory 430 may include a random access memory (RAM), a read only memory (ROM), and/or another type of dynamic or static storage device (e.g., a flash memory, a magnetic memory, and/or an optical memory) that stores information and/or instructions for use by processor 420.

Storage component 440 may store information and/or software related to the operation and use of a device 400. For example, storage component 440 may include a hard disk (e.g., a magnetic disk, an optical disk, and/or a magneto-optic disk), a solid state drive (SSD), a compact disc (CD), a digital versatile disc (DVD), a floppy disk, a cartridge, a magnetic tape, and/or another type of non-transitory computer-readable medium, along with a corresponding drive.

Input component 450 may include a component that permits a device 400 to receive information, such as via user input (e.g., a touch screen display, a keyboard, a keypad, a mouse, a button, a switch, and/or a microphone). Additionally, or alternatively, input component 450 may include a component for determining location (e.g., a global positioning system (GPS) component) and/or a sensor (e.g., an accelerometer, a gyroscope, an actuator, another type of positional or environmental sensor, and/or the like). Output component 460 may include a component that provides output information from device 400 (via, for example, a display, a speaker, a haptic feedback component, an audio or visual indicator, and/or the like).

Communication interface 470 may include a transceiver-like component (e.g., a transceiver, a separate receiver, a separate transmitter, and/or the like) that enables a device 400 to communicate with other devices, such as via a wired connection, a wireless connection, or a combination of wired and wireless connections. Communication interface 470 may permit device 400 to receive information from another device and/or provide information to another device. For example, communication interface 470 may include an Ethernet interface, an optical interface, a coaxial interface, an infrared interface, a radio frequency (RF) interface, a universal serial bus (USB) interface, a Wi-Fi interface, a cellular network interface, and/or the like.

A device 400 may perform one or more processes described elsewhere herein. A device 400 may perform these processes based on processor 420 executing software instructions stored by a non-transitory computer-readable medium, such as memory 430 and/or storage component 440. As used herein, the term “computer-readable medium” may refer to a non-transitory memory device. A memory device may include memory space within a single physical storage device or memory space spread across multiple physical storage devices.

Software instructions may be read into memory 430 and/or storage component 440 from another computer-readable medium or from another device via communication interface 470. When executed, software instructions stored in memory 430 and/or storage component 440 may cause processor 420 to perform one or more processes described elsewhere herein. Additionally, or alternatively, hardware circuitry may be used in place of or in combination with software instructions to perform one or more processes described elsewhere herein. Thus, implementations described herein are not limited to any specific combination of hardware circuitry and software.

The quantity and arrangement of components shown in FIG. 4 are provided as an example. In practice, a device 400 may include additional components, fewer components, different components, or differently arranged components than those shown in FIG. 4. Additionally, or alternatively, a set of components (e.g., one or more components) of a device 400 may perform one or more functions described as being performed by another set of components of a device 400.

As indicated above, FIG. 4 is provided as an example. Other examples may differ from what is described with regard to FIG. 4.

Persons of ordinary skill in the art will appreciate that the aspects encompassed by the present disclosure are not limited to the particular exemplary aspects described herein. In that regard, although illustrative aspects have been shown and described, a wide range of modification, change, and substitution is contemplated in the foregoing disclosure. It is understood that such variations may be made to the aspects without departing from the scope of the present disclosure. Accordingly, it is appropriate that the appended claims be construed broadly and in a manner consistent with the present disclosure.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software.

As used herein, satisfying a threshold may, depending on the context, refer to a value being greater than the threshold, greater than or equal to the threshold, less than the threshold, less than or equal to the threshold, equal to the threshold, or not equal to the threshold, among other examples, or combinations thereof.

It will be apparent that systems or methods described herein may be implemented in different forms of hardware, firmware, or a combination of hardware and software. The actual specialized control hardware or software code used to implement these systems or methods is not limiting of the aspects. Thus, the operation and behavior of the systems or methods were described herein without reference to specific software code-it being understood that software and hardware can be designed to implement the systems or methods based, at least in part, on the description herein.

Even though particular combinations of features are recited in the claims or disclosed in the specification, these combinations are not intended to limit the disclosure of various aspects. In fact, many of these features may be combined in ways not specifically recited in the claims or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (for example, a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, etc.), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An intercept device configured and deployed by a host server to operate between a user device and the host server, the intercept device comprising:
a processor; and
a memory communicatively coupled to the processor, the processor and the memory being configured to:
intercept, based at least in part on the host server determining that the user device has prevented the host server from utilizing cookies, a request transmitted by the user device to the host server, the request including (i) analytic data indicating user behavior and (ii) data of interest to be provided by the host server in a response;
transmit the request to the host server;
asynchronously extract the analytic data from the request;
transmit the analytic data to an analytics server for performance of analytics on the analytic data;
receive, from the analytics server, a result of performance of the analytics on the analytic data, the analytics server being separate from the intercept device and the host device;
determine, based at least in part on analyzing the result in real time, whether the response from the host server is to be modified;
selectively effect modification of the response based at least in part on determining whether the response from the host server is to be modified, wherein a selectively effected modification includes (i) information specific to a current location of the user device, the current location being determined by the intercept device based at least in part on utilizing an internet protocol (IP) address associated with the user device, (ii) low latency data that is compatible with mobile technology based at least in part on determining that the user device is utilizing the mobile technology to access the network, or high-definition video streaming data that is compatible with stationary technology based at least in part on determining that the user device is utilizing the stationary technology to access the network, and (iii) encrypted content to mitigate effects of potential security threats; and
transmit the response to the user device.

2. The intercept device of claim 1, wherein, to selectively effect modification of the response, the processor and the memory are configured to utilize a local writer to modify the response.

3. The intercept device of claim 1, wherein, to selectively effect modification of the response, the processor and the memory are configured to transmit a message to request additional information from the host server to enable the intercept device to modify the response.

4. The intercept device of claim 1, wherein, to selectively effect modification of the response, the processor and the memory are configured to modify the response by adding a custom header that is formatted to indicate to the user device that the custom header includes information customized for the user device.

5. The intercept device of claim 1, wherein, to selectively effect modification of the response, the processor and the memory are configured to transmit a message to the host server for the host server to modify the response.

6. The intercept device of claim 1, wherein, to selectively effect modification of the response, the processor and the memory are configured to selectively effect modification of the response without utilizing cookies.

7. The intercept device of claim 1, wherein the processor and the memory are configured to determine, based at least in part on analyzing the result, a behavior of a user of the user device while communicating with the host server.

8. A method in an intercept device configured and deployed by a host server to operate between a user device and the host server, the method comprising:
intercepting, by the intercept device based at least in part on the host server determining that the user device has prevented the host server from utilizing cookies, a request transmitted by the user device to the host server, the request indicating (i) analytic data indicating user behavior and (ii) data of interest to be provided by the host server in a response;
transmitting, by the intercept device, the request to the host server;
asynchronously extracting, by the intercept device, the analytic data from the request;
transmitting, by the intercept device, the analytic data to an analytics server for performance of analytics on the analytic data;
receiving, by the intercept device from the analytics server, a result of performance of the analytics on the analytic data, the analytics server being separate from the intercept device and the host device;
determining, by the intercept device based at least in part on analyzing the result in real time, whether the response from the host server is to be modified;
selectively effecting, by the intercept device, modification of the response based at least in part on determining whether the response from the host server is to be modified, wherein a selectively effected modification includes (i) information specific to a current location of the user device, the current location being determined by the intercept device based at least in part on utilizing an internet protocol (IP) address associated with the user device, (ii) low latency data that is compatible with mobile technology based at least in part on determining that the user device is utilizing the mobile technology to access the network, or high-definition video streaming data that is compatible with stationary technology based at least in part on determining that the user device is utilizing the stationary technology to access the network, and (iii) encrypted content to mitigate effects of potential security threats; and
transmitting, by the intercept device, the response to the user device.

9. The method of claim 8, wherein selectively effecting modification of the response includes the intercept device utilizing a local writer to modify the response.

10. The method of claim 8, wherein selectively effecting modification of the response includes the intercept device transmitting a message to request additional information from the host server to enable the intercept device to modify the response.

11. The method of claim 8, wherein selectively effecting modification of the response includes the intercept device adding a custom header that is formatted to indicate to the user device that the custom header includes information customized for the user device.

12. The method of claim 8, wherein selectively effecting modification of the response includes the intercept device transmitting a message to the host server for the host server to modify the response.

13. The method of claim 8, wherein selectively effecting modification of the response includes selectively effecting modification of the response without utilizing cookies.

14. The method of claim 8, further comprising:
determining, based at least in part on analyzing the result, a behavior of a user of the user device while communicating with the host server.

15. A non-transitory computer-readable medium configured to store instructions, which when executed by a processor associated with an intercept device that is configured and deployed by a host server to operate between a user device and the host server, configure the processor to:
intercept, based at least in part on the host server determining that the user device has prevented the host device from utilizing cookies, a request transmitted by the user device to the host server, the request including (i) analytic data indicating user behavior and (ii) data of interest to be provided by the host server in a response;
transmit the request to the host server;
asynchronously extract the analytic data from the request;
transmit the analytic data to an analytics server for performance of analytics on the analytic data;
receive, from the analytics server, a result of performance of the analytics on the analytic data, the analytics server being separate from the intercept device and the host device;
determine, based at least in part on analyzing the result in real time, whether the response from the host server is to be modified;
selectively effect modification of the response based at least in part on determining whether the response from the host server is to be modified, wherein a selectively effected modification includes (i) information specific to a current location of the user device, the current location being determined by the intercept device based at least in part on utilizing an internet protocol (IP) address associated with the user device, (ii) low latency data that is compatible with mobile technology based at least in part on determining that the user device is utilizing the mobile technology to access the network, or high-definition video streaming data that is compatible with stationary technology based at least in part on determining that the user device is utilizing the stationary technology to access the network, and (iii) encrypted content to mitigate effects of potential security threats; and
transmit the response to the user device.

16. The non-transitory computer-readable medium of claim 15, wherein, to selectively effect modification of the response, the processor is configured to utilize a local writer to modify the response.

17. The non-transitory computer-readable medium of claim 15, wherein, to selectively effect modification of the response, the processor is configured to transmit a message to request additional information from the host server to enable the intercept device to modify the response.

18. The non-transitory computer-readable medium of claim 15, wherein, to selectively effect modification of the response, the processor is configured to modify the response by adding a custom header that is formatted to indicate to the user device that the custom header includes information customized for the user device.

19. The non-transitory computer-readable medium of claim 15, wherein, to selectively effect modification of the response, the processor is configured to transmit a message to the host server for the host server to modify the response.

20. The non-transitory computer-readable medium of claim 15, wherein, to selectively effect modification of the response, the processor is configured to selectively effect modification of the response without utilizing cookies.
